(19) United States
(12) Patent Application Publication
(10) Pub. No.: US 2022/0019720 A1
(43) Pub. Date: Jan. 20, 2022

(54) FRAMEWORK FOR AUTOMATED SYNTHESIS OF SECURE, OPTIMIZED SYSTEM-ON-CHIP ARCHITECTURES

(71) Applicant: University of Florida Research Foundation, Incorporated, Gainesville, FL (US)

(72) Inventors: Swarup Bhunia, Gainesville, FL (US); Sandip Ray, Gainesville, FL (US); Atul Prasad Deb Nath, Gainesville, FL (US)

(21) Appl. No.: 17/375,790

(22) Filed: Jul. 14, 2021

Related U.S. Application Data
(60) Provisional application No. 63/053,118, filed on Jul. 17, 2020.

(51) Int. Cl. G06F 30/337; G06F 21/71; H04L 9/08

(52) U.S. Cl. CPC G06F 30/337; G06F 2115/02; H04L 9/08; G06F 21/71

(57) ABSTRACT

Systems and methods generate the design of a tiled multi-core system-on-chip (SoC). Design specification defining a multitude of cores to be used in the tiled multi-core SoC is analyzed and a multitude of subsystems based on the plurality of cores is built. The subsystems are augmented with one or more network adapters to generate the design of the tiled multi-core SoC. To achieve this, a multitude of IP blocks defined by the specification are retrieved from a design library. Design metadata associated with the IP blocks are extracted. Next, a standardized interface is generated for each of the IP blocks using the design metadata. Thereafter, a bus interface is generated for the IP blocks. Next, a tiled synthesizable register-transfer level code for the SoC design is generated in accordance with received configuration information.

### RELATED APPLICATION

The present application claims benefit under 35 USC 119(e) of U.S. Patent Application No. 63/053,118, filed Jul. 17, 2020, the content of which is incorporated herein by reference in its entirety.

### TECHNICAL FIELD

The present disclosure relates to integrated circuits, and more particularly, to computer-aided electronic design tool for automated synthesis and design of System-on-Chip

### BACKGROUND

In the past, designing of System-on-Chip (SoC) architectures was carried out by integrating Intellectual Properties (IPs) through instantiation of modules and drawing interconnect fabrics with schematic editors. The IP integration task was typically deemed as one of the final steps in the SoC development cycle where the ports of the IPs were interfaced mostly by drawing graphical wires. With the advent of Register Transfer Level (RTL) descriptions, designers began RTL code editing in conjunction with schematic drawing. However, such manual specification of port connections and IP interfaces is a challenging and intricate task. Moreover, sole reliance on SoC designer's expertise in IP integration is not a viable option for large, complex SoC designs as it leads to inefficiency and erroneous results. Consequently, these approaches became obsolete as they failed to scale with the increasing design complexities of modern designs.

As an alternative, connectivity through specifications and scripts has been introduced and adopted by many companies in the Electronic Design Automation (EDA) industry to address IP integration challenges. While these approaches can expedite the integration process to some extent, it is quite difficult to cater to the requirements of a complex SoC design flow with hundreds of IPs and subsystems that are connected, instantiated, configured, and refined continuously throughout the integration process within a demanding time-frame. As a result, SoC integration has become increasingly challenging problem in the EDA industry.

Further, the lack of standardization and high reliance on human expertise and creativity make current approaches for security feature integration quite ad-hoc. Currently, there is no disciplined mechanisms for implementing these policies in current industrial practice, e.g., architects that exploit various architectural features and system artifacts to creatively implement security policy requirements in practice.

Therefore, a need continues to exist for improved design flow in synthesizing SoC architectures. In addition, a need exists in the industry for streamlining the integration of security features into existing design flow while enabling IP integration and design optimization.

### BRIEF SUMMARY

Based on the design constraints and boundary conditions on area, power, and/or performance, set by the user, a system-on-chip (SoC) compiler, in accordance with embodiments of the present disclosure, is adapted to facilitate optimum selection of IP cores, interconnect fabrics, design parameters, and interconnect topology. In addition, embodiments of the present disclosure provide significant flexibility in security feature integration via standardized test wrappers, smart security wrappers, and debug wrappers, thereby facilitating optimization of security feature integration based on the requirements of target designs and use cases. Thus, embodiments of the present disclosure enable optimization in terms of major system parameters such as area, power, performance, and/or security thus to enable the generation of SoC designs customized for domain specific applications.

Embodiments of the present disclosure achieve a wide variety of secure and optimized SoC designs by: (1) automating the process of IP integration and allowing configurable assembly of complex, scalable systems; (2) enabling systematic integration of security features to generate SoCs while ensuring system trustworthiness via correct-by-construction security architectures; (3) facilitating the evaluation and optimization of generated designs in terms of critical system parameters, such as, power, area, performance, and security. Thus, embodiments of the present disclosure are adapted to include security feature as an integral part of the design and synthesis flow. Moreover, embodiments of the present disclosure enhance the flexibility of design optimization based on user specified design constraints through an automated and configurable framework.

### BRIEF DESCRIPTION OF THE DRAWING

FIG. 1 is a simplified high-level view of a flow performed by an SoC compiler, in accordance with one embodiment of the present disclosure.

FIG. 2 is a flowchart showing a multitude of steps performed by an HDL analyzer module of the SoC compiler, in accordance with one embodiment of the present disclosure;

FIG. 3 is a flowchart showing a multitude of steps performed by an SoC generator module, in accordance with one embodiment of the present disclosure.

FIG. 4 is a flowchart showing a multitude of steps performed by a system generator module, in accordance with one embodiment of the present disclosure.

FIG. 5 is a flowchart showing multitude of steps performed by an SoC compiler to generate a synthesizable RTL code for an SoC, in accordance with one embodiment of the present disclosure.

FIG. 6 is a high-level schematic view of various components of an SoC generated in accordance with one embodiment of the present disclosure.

FIG. 7 is a high-level schematic view of various components of an SoC generated in accordance with one embodiment of the present disclosure.

FIG. 8 shows a table illustrating a number of different variants of a cluster of SoCs with varying IPs and associated area and power scores generated in accordance with embodiments of the present disclosure.

FIG. 9 is a schematic of a computing system that may be used in accordance with various embodiments of the present disclosure.

### DETAILED DESCRIPTION

Embodiments of the disclosure provide a novel tool-flow-methodology (TFM) to automatically synthesize secure, optimized SoC architectures customized for diverse applications. Various embodiments provide techniques that include an automated SoC integration methodology based on the standardization of IPs to promote interoperability across open-source and industry standard interfaces, bus definitions, and Network-on-Chip (NoC) fabric protocols. Accordingly, embodiments of the present disclosure enable automated and efficient assembly and connectivity of complex, configurable systems with flexibility in developing large-scale SoCs comprised of application specific subsystems.

In one embodiment, systematic coordination of predesigned IP blocks that are standardized for fast and efficient integration are achieved. By enabling IP standardization and representing the design collaterals in a structured, disciplined way, the complexities involved in the SoC development processes are removed, and further, the process of SoC integration is automated to enable rapid design space exploration, flexibility in design configuration, parametric optimization, and streamlining of the entire process of RTL prototyping.

In addition, various embodiments provide a novel CAD flow for automated generation of secure and optimized SoCs. The modular tool framework of various embodiments allows users to build custom SoCs and subsystems, and gradually develop tiled many-core and multi-core large-scale systems based on design fidelity and application requirements. In particular embodiments, a well-defined user-friendly interface is provided that works in tandem with existing tool flows offered by many major industrial manufacturer including Synopsys, Cadence, and Mentor.

Further, various embodiments provide a systematic methodology to enable streamlined and automated integration of security features to traditional designs through a secure SoC generation flow. In some instances, the trustworthiness of generated SoCs can be guaranteed by a set of standardized security architectures including Institute of Electrical and Electronics Engineers (IEEE) standard test wrappers, configurable smart security wrappers, design-for-debug (DfD) wrappers, and a centralized, plug-n-play infrastructure IP for security. As a result, designers can build secure systems from the ground up via systematic implementation of fine-grained security policies that can be realized by supported security architectures of various embodiments. Accordingly, case studies on automated integration of security features to generate SoC benchmarks are provided herein that show how the framework can help design secure systems that are correct by construction.

Furthermore, various embodiments provide a flexible and configurable framework to evaluate and optimize automatically generated SoC designs against major, critical design parameters such as power, area, performance, and security. The fast prototyping and synthesizable SoC generation options of various embodiments enable the performance of rapid design evaluation and iterative optimization of designs targeted for domain specific applications including Internet of Things (IoT) and automotive systems.

A synthesis framework, provided in accordance with some embodiments of the present disclosure, enable the creation of an automated SoC benchmarking suite capable of generating a wide class of flexible, highly configurable SoC benchmarks including hierarchical shared-bus based SoCs and subsystems, and tiled many-core and multi-core complex SoCs with NoCs and shared-buses as interconnect fabrics. For instance, in particular embodiments, the benchmark suite incorporates an easily extendable, open-source, heterogeneous IP library that contains major components of present day commercial SoCs.

A method and system that streamlines the SoC integration process and enables designers to generate a wide-variety of optimized SoC designs, in accordance with one embodiment of the present disclosure, includes a CAD framework and associated EDA tools that provide an optimized design composition, and generate SoC benchmarks, as described further below.

The CAD framework and associated EDA tools, among other advantages, provide for standardization of IPs, and promotes interoperability across open-source and industry standard interfaces and interconnect protocols. The CAD framework enables automated assembly and connectivity of complex, configurable systems with flexibility in developing large-scale SoCs that include application specific sub-systems. The modular framework enables the designers to create single core SoCs and sub-systems from ground up and gradually build tiled many-core and multi-core large-scale systems. The CAD framework operates in tandem with existing commercially available EDA tools.

Embodiments of the present disclosure achieve optimized design composition by enabling SoC design space exploration and parametric optimization in terms of area and power constraints. An EDA tool, in accordance with one aspect of the present disclosure, exhaustively generates SoC variants based on designer provided specifications and delivers area and power optimized SoC designs. The streamlined methodology of fast RTL prototyping facilitates rapid design evaluation and optimization for targeted applications such as IoT and automotive systems.

Embodiments of the present disclosure provide SoC benchmark generation by facilitating SoC synthesis and enabling a designer to generate a relatively large number of SoC benchmarks with minimum effort. The EDA tool may be used to generate a wide class of flexible, highly configurable SoC benchmarks, including hierarchical shared-bus based SoCs and subsystems, and tiled many-core and multi-core complex SoCs with NoCs and shared-bus as interconnect fabrics. The tool is easily extendable and can readily incorporate open-source IP libraries that contains the major building blocks of commercially available SoCs.

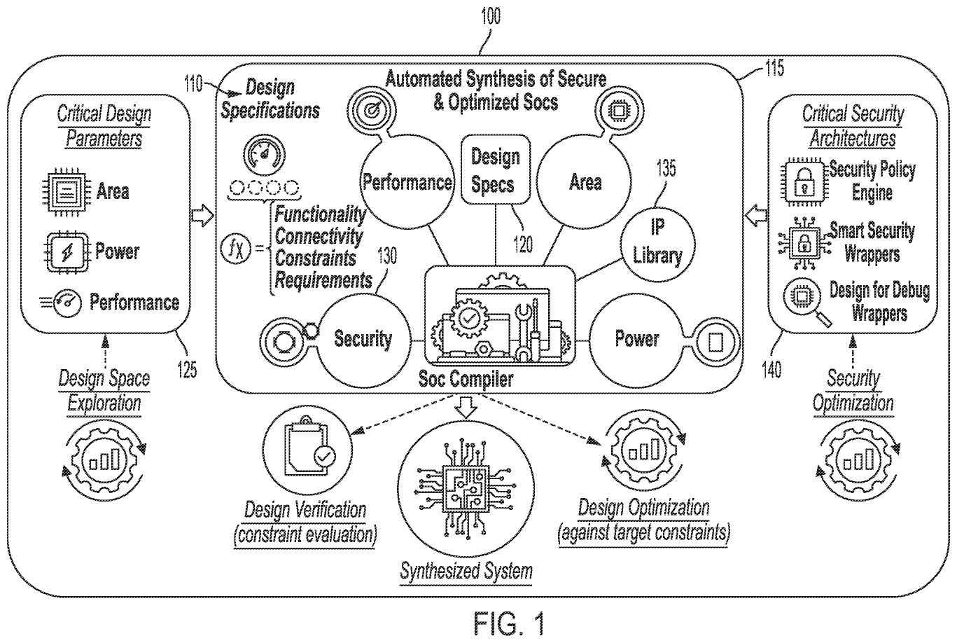

FIG. 1 is a simplified high-level view of a flow 100 performed by an SoC compiler (alternatively referred to herein as SoCCom) 115, in accordance with one embodiment of the present disclosure. As described further below, SoCCom 115 enables design configurability at varying granularity of abstraction including system level assembly and connectivity to IP level micro. The SoCCom 115 is adapted to receive, in part, design specification 120, security specifications 130, a standard IP library 135, and pre-defined power, performance, and/or area performance constraint 125 from a designer and generate, in response, synthesizable RTL designs (e.g., Vertilog/System Vertilog, VHDL, and the like) from such specifications. The RTL-based design can then be simulated and/or synthesized on Application-Specific Integrated Circuits (ASICs) and Field-Programmable Gate Arrays (FPGAs) and optimized for critical design parameters such as power, area, performance, and security. and enable users to generate complex

The design specifications may be in the form of standardized files for storing simple data structures and objects such as JSON or XML files. Such files define the SoC architecture in terms of IP cores, and SoC topology. The global (system-level), and local (IP-level) parameters of the SoC platform including the area, performance, and power constraints are also described by these files as optional parameters.

Using the design specification files, SoCCom may generate a graphical representation of the overall system topology. Each entity e.g., an IP core or a router is considered a node in the system graph, and the connection between the nodes are shown as the edges e.g., the links of an NoC fabric. By organizing the building blocks of an SoC design in a well-defined, structured way, such as the nodal graph, embodiments of the present disclosure streamline the SoC integration process via SoCCom, and further, automate the entire flow while overcoming the complexities of manual integration. Moreover, the optimized design generation components of the SoCCom enable a designer to develop SoCs with optimally selected IP blocks from the standard library, based on the prespecified design and security constraints.

The SoCCom exhaustively generates the possible designs and reports area, performance, and power optimized designs with a standardized metric. The SoCCom is therefore adapted to automatically generate SoC models in the form of synthesizable Verilog, SystemVerilog, as well as VHDL RTL design files. The SoCCom is also adapted to generate corresponding configuration files based on the user description, and instantiates respective modules (e.g., memory-mapped hardware accelerators, peripherals, and I/Os) accordingly. Furthermore, the rapid design generation process enables a user/designer to iteratively evaluate and optimize the designs against the critical parameters 125 to meet the design specifications 110.

Functional validation of the generated RTL-based SoC designs can be performed using commercially available and open-source simulation tools. Moreover, the RTL designs can be synthesized using existing tools to develop FPGA and ASIC oriented SoC prototypes. The SoCCom is fully compatible with the existing SoC design flow and can be configured to work in tandem with commercially available EDA tools.

The SoCCom enables a user to augment the generated designs with standardized security blocks 130 for systematic implementation of security features at IP and SoC-level. The user can analyze the trade-offs between the security features and design specifications in terms of critical design parameters, such as area, power and performance, collectively identified as 125, so as to optimize the designs to meet the desired goals.

Design specifications 120 define the SoC architecture that may include components such as cores and peripherals, interconnect fabrics, interconnect topology, IP connectivity, system level assembly, and the like. In addition, the base configurations of the SoC platform that include global (system-level) and local (IP-level) parameters may also be described through design specifications 120. Further, design specifications 120 may describe the security requirements of the platform by specifying the integration choices of standardized test wrappers, smart security wrappers, and/or design-for-debug (DfD) wrappers that are integral parts of the security architecture, and are collectively identified in FIG. 1 as 140.

In some embodiments, the standard IP library includes open-source hardware design blocks. For instance, the library may include processors, such as RISC-V processors, memory modules and controllers, digital signal processing (DSP) modules, cryptographic engines, IPs for off-chip communication including Serial Peripheral Interface (SPI) and Universal asynchronous receiver-transmitter (UART), and/or the like. In some embodiments, the library can be augmented with user specific IPs.

As described above, the SoCCom, in accordance with one embodiment of the present disclosure, is modular and scalable, enables a designer to generate relatively simple, single bus-based SoCs to complex many-core and multi-core NoC-based SoCs with hierarchical bus-based sub-systems. In one embodiment, a SoCCom includes, in part, an HDL analyzer, a hierarchical SoC and sub-system generator, and a tiled many-core and multi-core system generator, the description of each of which is provided below.

HDL Analyzer Module

IP interface standardization facilitates the SoC design process by ensuring that all IPs are integration-ready. Thus, the HDL analyzer module is configured in various embodiments to standardize and formalize the IP interfaces. The HDL analyzer module uses a systematic approach to extract and aggregate ports and interfaces as IP metadata, and facilitates the automated SoC integration process. In addition, the module provides for IP interoperability with various open-source and industry standard bus and NoC definitions through the standardization and utilization of the metadata.

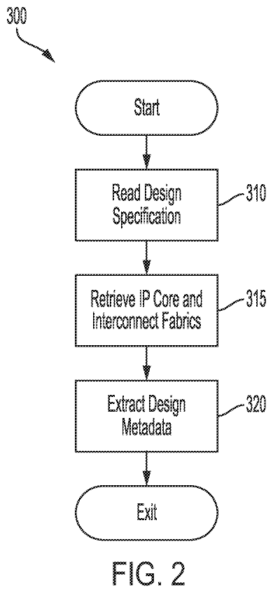

FIG. 2 is a flowchart 300 of a number of processes performed by an HDL analyzer module, in accordance with one embodiment of the present disclosure. As shown, at 310, the HDL analyzer module reads the design specification (see design specification 110 shown in FIG. 1), and architecture definition. At 315, the HDL analyzer module retrieves the IP cores and interconnect fabrics present in the architecture definition from the specified design library. At 320, the HDL analyzer module extracts design metadata. The HDL analyzer module may employ one or more pre-designed functions on the IP blocks for efficient aggregation of a specific set of design elements including port and interface definitions, instances, parameters, header files, and/or the like.

The extracted design metadata may include functional inputs and outputs, bus and NoC interfaces, local and global parameters (e.g., specific to SystemVerilog designs), IP header files including define, import, and include, and/or the like. Accordingly, the extracted design metadata may then be used by SoCCom to standardize and generate common interfaces for each IP to make it integration-ready with respect to the components of interconnect networks (e.g., network adapters and routers) and shared-buses.

The HDL analyzer module may employ one or more regular expressions to analyze the HDL files such as utilizing Python built-in libraries and regular expression patterns to extract the IP metadata. Several classes and methods may be used to process the matched patterns and store the extracted information internally for further usage by the SoCCom framework. Below is an exemplary code performed by an HDL analyzer, in accordance with one embodiment of the present disclosure:

ALGORITHM 1
HDLAnalyzer

| | |
|---|---|
| 1: | function EXTRACT_HEADERS(self) |
| 2: | Extract Packages, Headers, and Include parameters |
| 3: | for x in Packages do |
| 4: | match ← param.findall(contents) |
| 5: | header.append(tuple(match)) |
| 6: | end for |
| 7: | end function |
| 8: | function EXTRACT_PARAM(self) |
| 9: | match ← param.findall(contents) |
| 10: | parameters.append(tuple(match)) |
| 11: | end function |
| 12: | function EXTRACT_IO(self) |
| 13: | io ← io_v.findall(contents) |
| 14: | for (IP_top_modules in topIPs) do |
| 15: | io[net_index] ← matches_io[i].strip( ) |
| 16: | end for |
| 17: | if (io.type = = ‘input’): |
| 18: | inputs.append(io_details) |
| 19: | elseif (io.type = = ‘inout’): |
| 20: | inouts.append(io_details) |
| 21: | else (io.type = = ‘output’): |
| 22: | outputs.append(io_details) |
| 23: | endif |
| 24: | end function |

SoC Generator Module

The SoC generator module generates SoC designs and subsystems with shared bus architectures. Such designs may be stand-alone, shared-bus based SoCs and/or sub-systems in complex, multi-core, and many-core systems. In one embodiment, the SoC generator module supports the generation of single and hierarchical multibus SoCs with Wishbone B3 and AXI4-Lite bus standards.

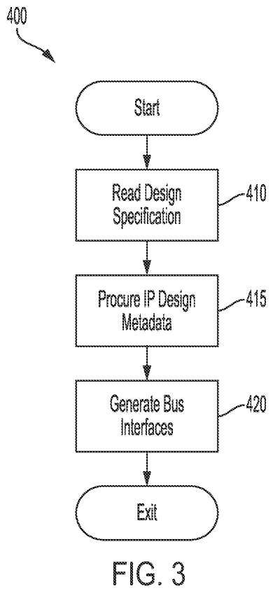

FIG. 3 is a flowchart 400 of a number of processes performed by an SoC generator module, in accordance with one embodiment of the present disclosure. The process flow begins with the SoC generator module procuring the design specifications from the user at 410. For example, as previously discussed, the design specifications may be provided via standardized data store/exchange file JSON/XML files. The architecture definitions disposed in the specifications generally include the basic components of the SoC such as, for example, the master and slave IPs, associated system and IP level design parameters, the bus type, the hierarchical bus topology, and the like.

The SoC generator module standardizes the IP core and its interfaces for bus integration to generate the SoC design using the HDL analyzer module to procure the IP design metadata at 415. The SoC generator module then utilizes the IP specific information to generate the bus interfaces at 420 for all the masters and slaves of the SoC and the subsystems with corresponding bus definitions and signals to generate the SoC design. For instance, typical system and IP level parameters may include address bus width, data bus width, memory size allocation, memory-mapped I/O, peripheral address size and ranges, and/or the like that the SoC generator module incorporates in the generated design in accordance with the user's specified configurations.

For hierarchical bus-based SoCs, the SoC generator module supports augmentation of Wishbone compatible IPs and SoCs with AXI4-Lite compatibility wrappers. The wrappers may include a standard bus-bridge to establish inter-bus communication that helps bus protocol conversion and ensure definition compatibility. The multi-bus structure enables the flexibility of integrating the open-source Wishbone bus compatible IPs and SoCs to the industry standard AXI4-Lite bus and thus, enhances IP and subsystem inter-operability. Below is an exemplary algorithm performed by the SoC generator module, in accordance with one embodiment of the present disclosure:

ALGORITHM 2
Hierarchical SoC Sub-system Generator

| | |
|---|---|
| 1: | function SoC GENERATOR(json_config) |
| 2: | IP_list ← IP_list.append[IP_names] |
| 3: | config ← config.append[IP_config] |
| 4: | if (bus.type = = ‘WB’ II ‘AXI’): |
| 5: | Instantiate AXI Crossbar if (bus.type = = ‘AXI’) |
| 6: | file.write [IP_list(config(Master))] |
| 7: | file.write [IP_list(config(Slave))] |
| 8: | else (bus.type = = ‘WB’ && ‘AXI’): |
| 9: | WB_IP_list.append(WB_to_AXI Bridge) |
| 10: | file.write(Instantiate Wishbone SoC) |
| 11: | AXI_IP_list.append(Wishbone SoC) |
| 12: | file.write(Instantiate AXI SoC) |
| 13: | endif |
| 14: | end function |

Tiled Many-Core and Multi-Core System Generator

The tiled many-core and multi-core system generator (alternatively referred to herein as the system generator module or system generator) is adapted to generate tiled many-core and multi-core SoCs with NoC fabric. The scalable architecture of tiled many-core SoCs facilitates the integration of numerous, e.g., hundreds, of IP cores to build large-scale, complex SoC designs. Accordingly, the system generator module enables the generation of NoC-based SoCs with processor and peripheral tiles. The tiled subsystems incorporate an internal shared-bus for local communication whereas the NoC fabric communication is established via network adapters connected to the tiles. Accordingly, the system generator module enables the development of SoCs with application specific subsystems connected to the on-chip fabric through the routers.

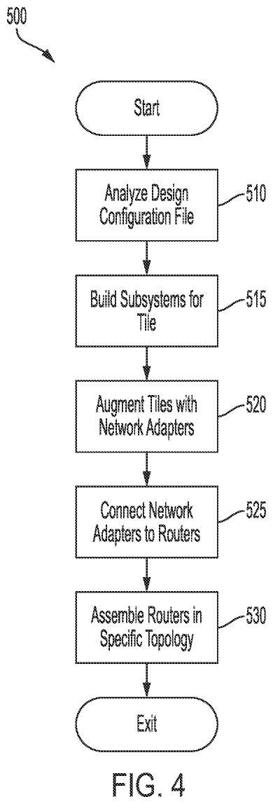

FIG. 4 is a flowchart 500 of a number of processes performed by a system generator module, in accordance with one embodiment of the present disclosure. At 510, the design configuration file is analyzed to provide base configuration information on the IP cores for the tile(s). The system generator module may access the configuration file from some data source (e.g., data storage) or may receive the file from the user.

Once the base configuration information has been analyzed, the system generator module analyzes the IP cores and builds the subsystems for the tile at 515. In one embodiment, the system generator module is configured to perform this operation by invoking the HDL analyzer module and the SoC generator module, described above, to analyze the IP cores and build the subsystems. The system generator module at 510 augments the generated subsystems with network adapters that make the subsystems and their corresponding bus definitions compatible to the network protocol. Next, the system generator module connects the network adapters in turn to the routers at 525. The system generator module assembles the routers in the specific topology provided by the base configuration file of the system to generate the design at 530.

Accordingly, the system generator module is configured in various embodiments to enable designers to generate NoC-based many-core and multi-core SoC designs in any arbitrary network and bus topology. In addition, since the framework is designed to represent the design connectivity as a nodal graph with end points in some embodiments, the design is amenable to any arbitrary topology formation. Below is an exemplary algorithm performed by the system generator module, in accordance with one embodiment of the present disclosure:

ALGORITHM 3
Tiled Manycore and Multicore System Generator

| | |
|---|---|
| 1: | function ExTRACTIO(IP Filepath, IP Filename) |
| 2: | Extract I/O, Parameters, and Headers from IPs |
| 3: | end function |
| 4: | function IP_INTERFACER(IP Filepath, IP Filename) |
| 5: | IP_NA ← Join IP top module with Network Adapter |
| 6: | IP_Router ← Join IP_NA with Router |
| 7: | return IP_Router |
| 8: | end function |
| 9: | top_IPs = [ ] |
| 10: | for (IPs in IP_l) do |
| 11: | topIPs.add(IP_Interfacer(IP_Filepath,IP_Filename) |
| 12: | end for |
| 13: | for (IP_top_modules in topIPs) do |
| 14: | Create NoC in configured topology |
| 15: | end for |

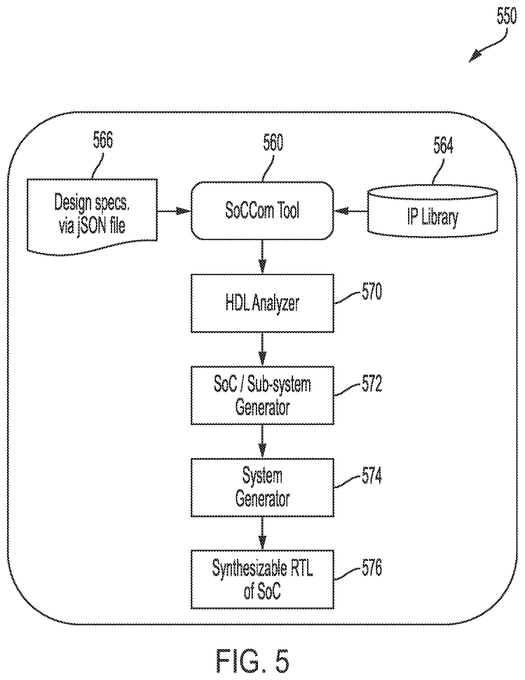

FIG. 5 is a flowchart 550 showing the various steps involved in generating a synthesizable RTL code for an SoC, in accordance with one embodiment of the present disclosure. At 560, design specification 566 and IP library 564 are provided to the SoCCom 560. At 570, the HDL analyzer module, as described above, standardizes and formalize the IP interfaces. Next at 572, the SoC subsystem generator module, as described above, uses the standardize IPs to generate the bus interfaces. Next, at 574, a system generator, as described above, generates the SoCs using, for example, an NoC fabric. Thereafter, at 576, a synthesizable RTL code is generated for the SoC.

Systematic Integration of Security Features

With the pervasive application of electronic chips in a variety of domains including mission-critical military and commercial operations, the security of SoC design is more crucial than ever, particularly, when there is a significant inadequacy of systematic methodologies and tool flow for SoC security feature integration that can be widely adopted by designers. Current practices typically rely on the adoption of ad-hoc mechanisms to integrate security features to SoCs on a use case and need basis. As performance of the system is given the highest priority in most scenarios, the addition of security features are often deemed too burdensome with vague economic benefits. This leads to the absence of security measures in a large number of SoC designs. Such vulnerability of chips results in an increasing number of attack surfaces, and in turn, leads to insecure, unreliable designs with degraded performance, if not completely impaired systems when exposed to adversarial attacks.

Various embodiments of the disclosure provided herein address the limitations of the status quo by integrating security features in SoCs from the bottom up starting from the early stages of design exploration and product development. Embodiments of the present disclosure enable the addition of security features in the chip design flow by streamlining and automating the integration of standardized security mechanisms that are scalable to modern-day SoC design complexity. Moreover, embodiments of the present disclosure provide such integration that can support adequate flexibility in terms of the extent of security measures while considering the trade-off between cost of security, performance, and design economy.

Various embodiments of the present disclosure enable the integration of the security features to be fully automated and streamlined with the existing SoC design flow by incorporating security requirements defined in the design specifications based on systematic security architectures built with standardized components including existing resources deployed for testing and debugging purposes. Embodiments of the present disclosure take advantage of the resources such as infrastructure IPs and standardized test and debug wrappers that are readily available on-chip in most designs. The exploitation of existing on-chip resources helps achieve a streamlined yet simplified addition of security features with minimal changes in current SoC design flow. Thus, various embodiments are configured to automate the integration of a variety of security features to generated SoC designs.

Automated Integration of E-IIPS Security Architecture

Referring to FIG. 1, SoCCom 115 is configured to provide automatic integration of a variety of security features to a generated SoC. In one embodiment, SoCCom 115 facilitates the automated addition of a flexible and standardized security architecture, referred to herein as Extended Infrastructure IP for Security (E-IIPS), for systematic implementation of IP and system-level security policies in generated SoC designs. The E-IIPS architecture can ensure provable system resilience against diverse run-time security violations and major inter-IP communication attacks. The architecture can have one or more of several distinctive features: (1) a dedicated, centralized, patchable plug-and-play infrastructure IP block, referred to as security policy engine (SPE), that can implement a diverse set of fine-grained security policies, and operate as the security brain of the design. The SPE is developed in various implementations from the bottom up to systematically implement, patch, and upgrade diverse SoC security policies; (2) smart security wrappers to provide standard communication interfaces of IP blocks to the SPE, architected via augmentation of available test and debug wrappers. The wrappers enable communication of security-relevant events between various IPs in the SoC design and the SPE, and facilitate run-time monitoring and policy enforcement by the SPE; (3) a seamless, efficient, and low-overhead interface between the smart security wrappers and on-chip design-for-debug infrastructure for implementing an enhanced number of SoC security policies by obtaining additional controllability and observability over the security critical signals, while maintaining transparency of debug and validation usages. The flexible features of the E-IIPS security architecture in various embodiments enables a user to specify the security critical event of interest and update the policies in the SPE accordingly.

Automated Generation of Secure SoCs

As described above, SoCCom 115 is configured to leverage the E-IIPS architecture to automatically integrate security features into generated SoCs. SoCCom 115 facilitates the automatic integration of the building blocks of the E-IIPS architecture e.g., baseline test wrappers, smart security wrappers, DfD infrastructures, the centralized infrastructure IP, and/or the like in tandem with existing SoC design flow. SoCCom 115 is configured to generate secure SoCs with IP specific wrappers and the centralized SPE based on defined security requirements found in the design specifications. The highly configurable and modular nature of the framework enables a user to identify different versions of wrappers based on the security requirements of target systems and their use cases. For example, the user can select from IEEE Standard P1500 test wrappers, smart security wrappers with security critical event specification, and/or DfD wrappers for enhanced controllability and observability over an augmented number of critical signals.

In some embodiments, SoCCom 115 incorporates two different versions of the SPE: (1) a firmware upgradeable micro-controlled implementation, and (2) a reconfigurable SPE designed for embedded FPGAs. Accordingly, users can configure the security architecture integration based on domain specific applications of the target systems. In addition, SoCCom 115 is configured to enable a user to implement a diverse set of arbitrary policies to ensure the SoC trustworthiness via correct-by-construction architectures. Further, in some embodiments, the E-IIPS architecture enables the user to update the security policies for the entire system by updating the firmware or FPGA bitstream of the SPE. Thus, the systematic implementation of security policies provided in various embodiments can facilitate remote upgrade and patching of security requirements while incurring minimal overhead due to the efficient usage of on-chip test and debug resources.

SoC Asset, Firmware, and On-Chip Communication Protection

The security architecture provided in various embodiments can protect generated SoCs against a diverse set of threat models, a number of which are described herein. Security policies govern the integrity, confidentiality, and availability properties of SoC assets, firmware, and on-chip communication. SoCCom enables users to map these properties to actionable design constraints as security policies via the E-IIPS architecture. This enables the implementation of diverse security policies such as access control, information flow, TOCTOU (time-of-check vs time-of-use), liveness, and/or the like. In addition, integration of the SoCCom security architecture can help a user in building a trusted environment with untrusted IPs by comparing the micro-architecturally co-related events. Further, the security architecture can be augmented in some embodiments with distributed satellite units to address attacks on on-chip communications in NoC fabrics and reduce the communication overhead of a centralized implementation. The system and IP-level security policies enable a security architect to protect the SoC despite the presence of untrusted IPs and ensure resilient system operation through run-time detection and on-the-fly mitigation of threats. The threat model can include attacks originating from untrusted IPs, firmware, software modalities, and/or the like.

IC Authentication and Piracy Prevention

In some embodiments, a distributed ScanPUF primitive can be integrated with the security architecture for secure authentication of trusted ICs that is compatible with IPs including IEEE P1500 test wrappers. The ScanPUF architecture is achieved by the random delay variations in the scan-chain path of the cores. The distributed implementation allows an architect to verify the authenticity of each IP core individually. Accordingly, the PUF signatures may be generated by the manufactures and verified by the SoC integrators. In addition, the ScanPUF architecture does not require the keys to be stored on-chip. Instead, the SoC integrator can generate and extract the PUF keys and verify the authenticity of the chips by comparing the keys with manufacturer provided golden keys.

Hardware Trojan Detection

The security architecture in various embodiments incorporates distributed components of detecting hardware Trojans based on path delays introduced by the presence of a malicious Trojan circuitry in the original design. The architecture may be adapted to use an efficient clock sweeping technique to garner the path delays from individual IP through the centralized infrastructure. The tunable nature of the clock frequency enables security architects to have fine-grained control over the sweeping with a wide-range of coverage. While employing the path delay based Trojan detection method in the entire system is normally time-consuming, users (e.g., designers and/or security architects) in some embodiments can select the security critical IPs (e.g., memory controller, crypto IPs, secure memory modules, etc.) of the design to implement the Trojan detection mechanism and reduce implementation overhead.

Protection Against Scan-Based Side-Channel Attacks:

While scan-chain is prevalent as a design-for-test (DfT) architecture in most modern-day SoCs for enhanced test coverage with improved controllability and observability over the internal signals, it can be maliciously exploited by attackers to illegally access SoC assets (crypto keys for instance). The security architecture in various embodiments can provide a strong authentication mechanism to prevent any illegal scan-chain based side-channel attack. In particular, the distributed scan-chain based protection mechanism of the security architecture can gate the output values in case of a failed authentication in particular instances and thus, can prevent attackers from leaking a secret asset via scan-chains. Since most IPs employ scan-chain as DfT, the protection mechanism can be applied in many cases to the diverse IP cores of the SoCs.

Optimized Design Composition

Due to diverse nature of application domains, the design constraints and security requirements of SoCs can vary significantly. To fully realize the advantageous attributes of an SoC in diverse domain specific applications, it is crucial to optimize major design aspects of the architecture such as power, area, performance, and/or security. Existing design and optimization methodologies fail to provide adequate flexibility in optimization against design constraints based on domain specific applications. Currently, it is difficult to perform a rapid estimation of design overhead including power, area, performance, and/or security without prototype development or exhaustive simulation. However, this problem can often be alleviated if the process of developing simulation ready and synthesizable prototypes can be expedited via automation. More importantly, trade-offs between performance, area, power, and/or security can be understood better if the automated generation of designs support design optimization through a flexible and configurable framework.

Optimization Via Design Parameters

Various embodiments of the SoCCom solve the above-mentioned limitations by enabling automated, optimized composition of the SoC designs based on user-defined design specifications and security constraints provided in the design specifications. This enables a user to generate all possible SoC designs that meet the boundary conditions in terms of area, power, performance, and/or security. It also enables a user to configure and optimally select SoC design parameters based on the preferences of one design constraint over another. Specifically, embodiments of SoCCom enable the user to generate an area-optimized design while being lax on the performance and power constraints.

In addition, SoCCom enables a user to configure the IP specific local and system level parameters to meet design goals. For example, such local parameterization may be used to configure a RISC-V processor to support specific instruction set architectures. SoCCom can facilitate the implementation of different RISC-V ISA including integer, compressed, multiply and divide, and/or extended operations. The modular framework enables a user to add optional ISAs (compressed, extended, multiply and divide) in tandem with the mandatory integer ISA implementation.

Similarly, SoCCom enables the user to configure global parameters of a NoC-based tiled many-core system by configuring the system and NoC fabric parameters like enabling/disabling direct memory access, NoC virtual channels, and/or message passing via network adapters, configuring the number of router input/outputs and/or number of tiles, and/or configuring the size of the local memory, global memory, boot rom, and/or the like. The parameterizable, modular elements of SoCCom enables the user to explore the architectural design space at different levels of abstraction and varying granularities of system integration. Thus, SoCCom is further configured to help users optimize SoCs for meeting design and economic goals.

SoC Benchmarking

Lack of open-source, configurable SoC benchmarks is a major obstacle for SoC architecture research. The scarcity of configurable RTL-based SoC models compels researchers in academia and industry to opt for architectural simulators. However, the simulation-oriented prototypes fail to act as the right substitute of RTL-based implementations in many use cases. The architectural simulators often suffer from oversimplification of key architectural features since these design choices, for instance selecting specific features for in-depth implementation and abstracting out others, are based on the human expertise of simulation model developers. Moreover, the black-boxing of different design modules makes things worse by delivering quantitative results that lacks adequate validation and information about potential errors and bugs in the system.

SoCCom Generated Configurable Benchmarks

The SoCCom may be used as an automated SoC benchmark generation suite to address the above-mentioned problems. Specifically, the SoCCom may be used to generate a wide class of flexible and highly configurable SoC benchmarks including hierarchical shared-bus based SoCs and subsystems, and tiled many-core and multi-core complex SoCs with NoCs and shared-buses as interconnect fabrics. In some instances, the SoCCom can incorporate an easily extendable, open-source, heterogeneous IP library that contains major components of commercial SoCs such as, for example, RISC-V processors, single and dual-port memory modules, memory controllers, a variety of hardware accelerators, IPs for external communication, shared buses, routers, network-on-chip IPs, and/or the like.

Accordingly, a user can configure the SoCCom to generate SoC benchmarks with various classes of IPs and interconnects. For instance, the user can specify the IP types and interconnect fabric to generate all possible SoC designs within specified design constraints. Such benchmarking via embodiments by the SoCCom can provide the user with a diverse set of SoC models with area, power, performance, and/or security highlights. In the case of bus-based SoCs and subsystems, the SoCCom may be configured to generate SoCs with AXI4-Lite and Wishbone B3 shared buses. The SoCCom enables the generation of hierarchical bus-based SoCs with standardized bus bridges.

Once the user provides the number and types of IPs for a specific shared bus, the SoCCom generates all possible combinations of those bus-based SoCs with different parameter optimization and reports the final compositions in terms of area, power, performance, and/or security. Similarly, the user can configure the topology and router connections, the corresponding IPs, number of IPs in each routers, IPs in any specific subsystems, number of subsystems, and/or the like for NoC-based large-scale tiled systems. For instance, the SoCCom facilitates the incorporation of an open-source NoC, such as a LisNoC, that is highly parameterizable and amenable to arbitrary topology formation. Using the SoCCom, a user can generate different sets of SoC benchmarks for any specific topology while changing the IPs, the types of tiles, e.g., processor tile, memory tile, and/or hardware accelerator/peripheral tile, and their connections to the routers. Thus, the user can quickly generate many variations of system topology in these embodiments and study design performance by evaluating different positions of IPs and tiles with respect to routers and overall system topology.

SoCCom Generated Tiled Many-Core SoC Models

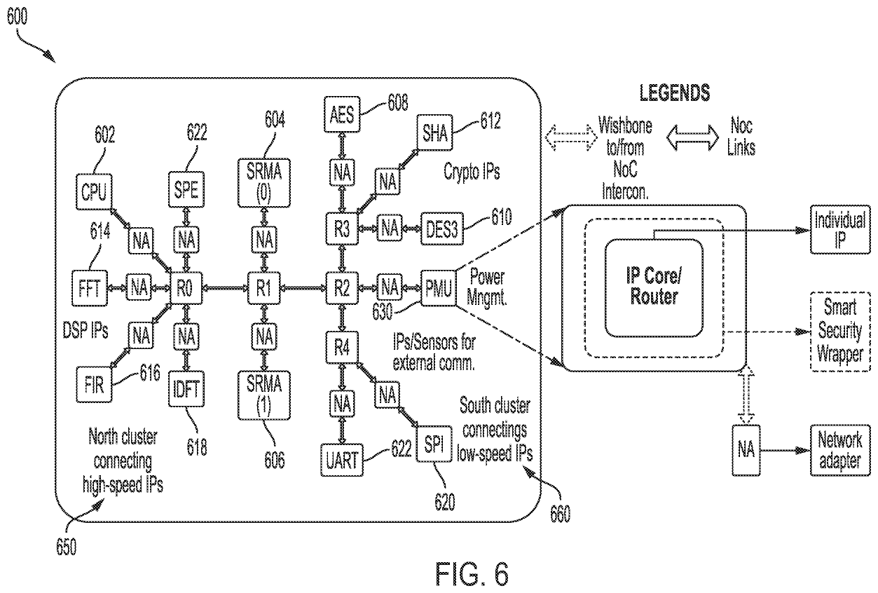

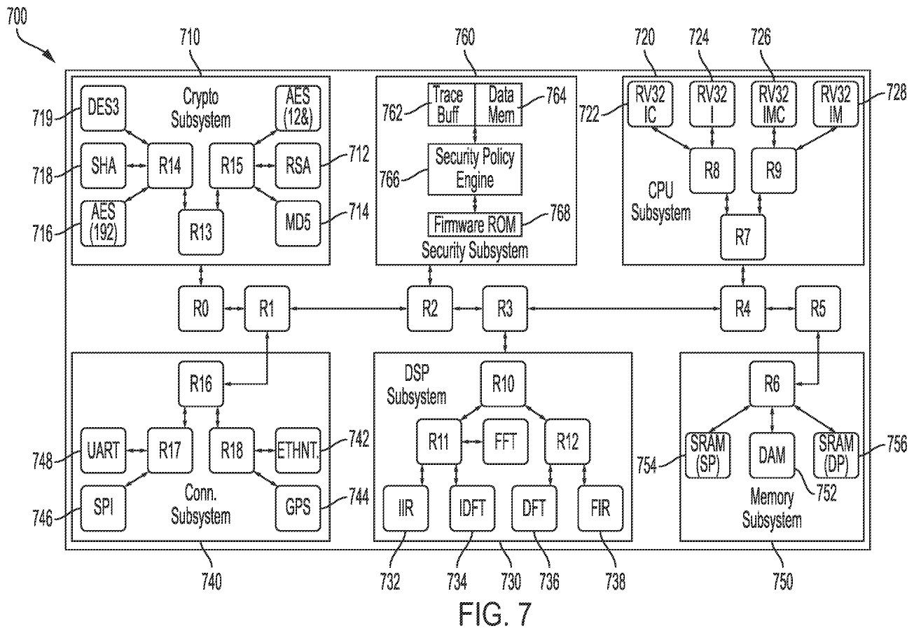

FIGS. 6 and 7 provide two illustrative SoC designs generated in accordance with various embodiments of the present disclosure. The SoC models shown in FIGS. 6 and 7 include a multitude of SoC components and indicate a number of features and complexities of NoC-based industrial SoC designs, including tree-based topology for routers, a mix of high-speed and low-speed IPs, and large-scale many-core system with application specific subsystems.

The cluster-based SoC 600 shown in FIG. 6 is depicted as including, among other components, a size-optimized RISC-V central processing unit (CPU) 602 (namely PicoRV32) and two dual port SRAMs 604, 606 integrated as memory modules. SoC 600 is also shown as including, in part, three crypto modules AES 608, DES3 610, and SHA 612 configured to perform cryptographic operations. SoC 600 is also shown as including, in part, three high-performance DSP blocks, namely fast Fourier transform (FFT) 614, finite impulse response (FIR) filter 616, and inverse discrete Fourier transform (IDFT) 618. The SPI controller 620 and UART module 622 are integrated in SoC 600 for external communication. Power management unit (PMU) 630 is included to facilitate power analysis. The IPs are shown as being segregated into two clusters. North cluster 650 is shown as including, high-speed IPs (e.g., CPU 602, FFT 614, FIR 616, IDFT 618). South cluster 660 is shown as including crypto modules AES 608, DES3 610, and SHA 612, PMU 630, and external communication IPS, such as UART 622 and SPI 620.

FIG. 7 shows an SoC design 700 that includes a crypto subsystem 710, a CPU subsystem 720, a connection subsystem 740, a DSP subsystem 730, a memory subsystem 750, and a security subsystem 760. As with realistic implementations, it has a much larger number of IPs organized into a number of subsystems. The CPU subsystem 720 is shown as including, in part, four, e.g., 32-bit RISC-V cores 722, 724, 726 and 728 that may be configured to support different instruction sets, and may be optimized to have different sizes. The crypto subsystem 710 is shown, as including, in part, an RSA module 712, an MD5 module 714, an AES module 716, a SHA module 718, and a DES3 module 719. The DSP subsystem 730 is shown as including, in part, a HR module 732, an IDFT module 734, a DFT module 736, and a FIR module 738. The memory subsystem 750 is shown, as including, in part, a DMA controller, a single-port SRAM 754, and a dual-port SRAM 756. The connectivity subsystem 740 is shown as including, in part, an Ethernet module 742, a GPS module 744, an SPI module 746, and a UART module 748. The security module 760 is shown as including, in part, a trace buffer 762, a data memory unit 764, a security policy engine 746 (SPE), and a firmware read-only memory (ROM) 748. The various modules shown in FIG. 7 may be IPs, as described above.

Both SoC designs 600 and 700 include modular and configurable open-source Network-on-chip, referred to as LiSNoC, as the interconnect fabric that supports wormhole-based flow control. The routing algorithm used in the SoCs may be dimension-ordered, deadlock-free XY-routing. The number of input ports, output ports, and allocation of virtual channels (VCs) to input-output ports are parameterizable. The flit transfer may be achieved through a handshaking protocol implemented with the ready and valid signals of each VC. The associated network adapters include DMA engines and message passing functionalities. The IPs may be wishbone-bus compatible. The network adapter facilitates their compatibility to NoC protocol. The IPs may be obtained from various open source repositories in Verilog and SystemVerilog RTL models. The SoC models 600, 700 may be functionally validated in ModelSim and synthesized in Xiling Vivado and Synposys Design Compiler. The secure SoC models 600, 700 may be generated with SPE modules 622 and 746, as described herein, to implement security features, implemented through an exemplary 32-bit 5-stage DLX micro-controller with dedicated instruction and data memory. Furthermore, each IP and router may be augmented with IEEE P1500 standard test wrappers and smart security wrappers.

Optimized Design Composition

Multi-objective design optimization is crucial for efficient deployment of SoC designs in various domains. However, as described above, existing SoC development frameworks fail to provide adequate flexibility in such optimization for domain specific applications. For instance, design overhead analysis via current frameworks require manual development of individual RTL models and/or exhaustive analysis of each software model via simulators. Embodiments of the present disclosure mitigate the above problems by enabling the trade-off analysis between multiple design objectives in terms of critical parameters (e.g., area and power) through a streamlined design flow, and thereby eliminate the manual steps involved in the SoC development and evaluation process, and further, deliver improved efficiency in multi-objective design optimization.

Multi-Objective Design Optimization

SoCCom is configured to provide automatic generation of designs optimized against multiple objectives. For example, it generates a comprehensive set of SoC models based on user provided design specifications and reports the most area and power optimized designs along with other variants within the boundary of design constraints. SoCCom exhaustively generates all possible combinations of designer specified SoCs with varying IP and system level parameters, IP variants, interconnects, and streamlines the area and power estimation of individual designs using existing commercial design tool. SoCCom reports SoC variants within the boundary conditions set by the designer and delivers a wide-variety of SoC designs across the range of prespecified constraints. SoCCom uses a standard area and power metric to help the user quantify implementation overhead in terms of target platform resources. SoCCom uses a metric ranging, for example, from 1 to 10 to denote the area and power score from low to high. The higher scores of area and power basically represent low area and power values of the design compared to other variants with high area and power overhead.

SoCCom is configured to report SoC variants that are configured with IP specific, i.e., local and system level, i.e., global parameters, to meet the area and power preferences of the designer. An example of local parameterization is configuring the RISC-V processor to support specific instruction set architectures (ISAs). SoCCom facilitates the implementation of different RISC-V ISA including integer, compressed, multiply and divide, and extended ISA. The modular framework allows a user/designer to add optional ISAs (compressed, extended, multiply and divide) in tandem with the mandatory integer ISA implementation.

Similarly, based on user provided metric, SoCCom is configured to present SoC variants optimized in terms of global parameters such as enabling/disabling direct memory access, NoC virtual channels, and message passing via network adapters, optimized sizes of local and global memory, etc. The parametric optimization features of SoCCom enables the designers to explore the architectural design space at different levels of abstraction and varying granularity of system integration.

Demonstrated below is the generation of optimized SoC compositions with multi-objective design goals via SoCCom and ClusterSoC, as an exemplary implementation. In this example, 5 IPs of ClusterSoC were selected to reduce the computational complexity of exhaustively generating every possible combination of SoC designs with variants of each IP component. SoC variants were exhaustively generated by employing all variations of the selected IPs. The IP variants, in this example, include 5 RISC-V cores with basic integer (I), extended (E), and multiply and divide (M) ISA implementation; 3 AES cores of 128-bits, 192-bits, and 256-bits; 6 fully streaming DFT and IDFT DSP cores of 32-bits, 64-bits, and 128-bits; and 3 different sizes (i.e., 8, 16, and 32 Mb) of on-chip RAM.

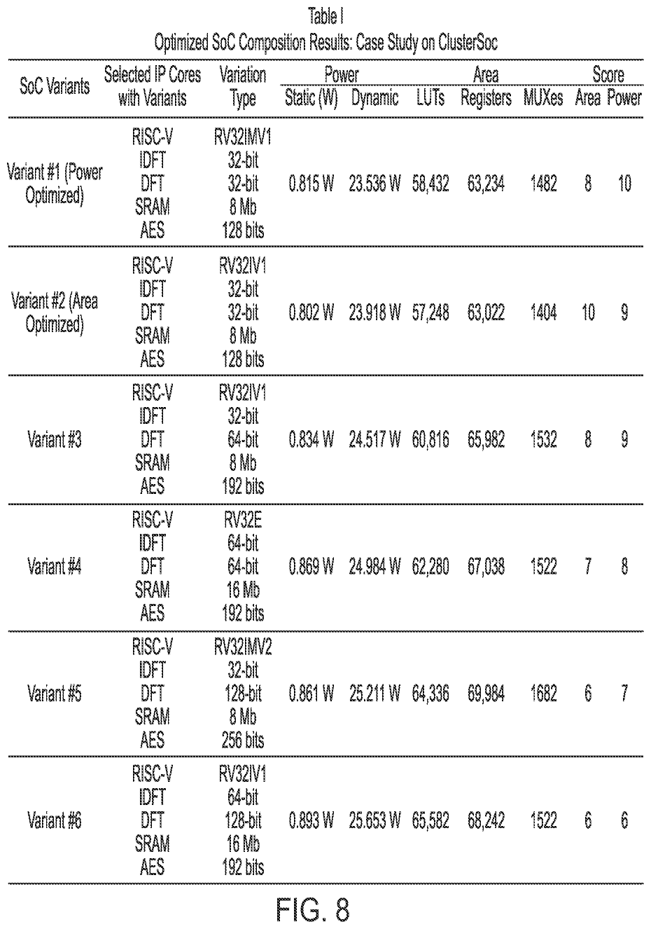

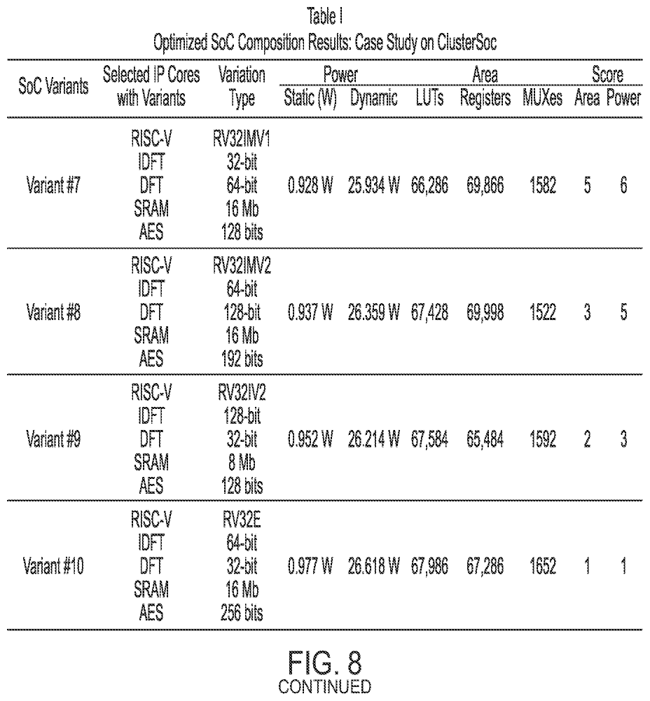

Table I, shown in FIG. 8, illustrates 10 different variants of ClusterSoC with varying IPs, and associated area and power scores that cover the entire spectrum of design constraints. The area and power overhead of the designs are reported based on the resource utilization at the target platform, which in this example is a Xilinx Zynq UltraScale+MPSoCs FPGA. SoCCom reports the resource utilization of the FPGA model in terms of MUXes, registers, and ALUs. The power analysis on the FPGA mapping is reported through the on-chip power broken down into dynamic and static power. As shown in Table I, variants 1 and 2 are the most power and area optimized SoCs, respectively, among the generated designs while variants 8, 9, and 10 score lower since they consume comparatively higher area and power.

As is described herein, SoCCom overcome the existing limitations of an SoC design by facilitating register-transfer level (RTL) design space exploration of the SoC design. SoCCom enables exploration of the SoC micro-architecture at varying levels of granularity including IP and system-level assembly. The modular design components of SoCCom enable fast design exploration of processor cores, memory controllers, hardware accelerators, shared-bus and NoC components including bus parameters, router micro-architecture, and system-level topologies. The generated, synthesizable Verilog and SystemVerilog designs may be further analyzed via RTL simulation or FPGA emulation. The SoCCom generated designs are vendor independent and may be integrated to existing designs. Hence, the SoC architects and researchers across academia and industry can equally exploit the design exploration features of SoCCom.

SoCCom generated SoCs may be used for fast simulation and data analytics. The generated SoCs help designers to get a deep understand of the crucial aspects of design operation such as QoS of on-chip traffic or power management for different IPs. Similarly, the execution traces and corresponding data sets of large-scale designs can be exploited for system optimization by performing intelligent analytical techniques and machine learning based approaches.

With its ability to deliver custom, configurable SoC models and fast RTL prototyping features, SoCCom may also be used in conducting research in all major aspects of the SoC design. Additionally, the wide class of generated SoC benchmarks enable the researchers to evaluate their work across different architectural designs.

SoCCom may be used in a multitude of technical fields including hardware security and trust, resilient architecture development, power-management, formal verification, and post-silicon validation to design and evaluate SoCs. An example of such use case in post-silicon validation is the used of execution trace analysis for reconstructing system-level behavior, referred to herein as specification mining. Conventional methods of specification mining are reliant on manual, human insight of the architects. A user/designer may use SoCCom generated SoCs to conduct in-depth research and develop novel approaches of system level behavior reconstruction. Since SoCCom supports the generation of many-core and multi-core large-scale SoCs, the user can exercise complex, system-level protocols of industrial SoCs and further explore the possibilities of re-constructing such on-chip interactions via trace patterns.

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

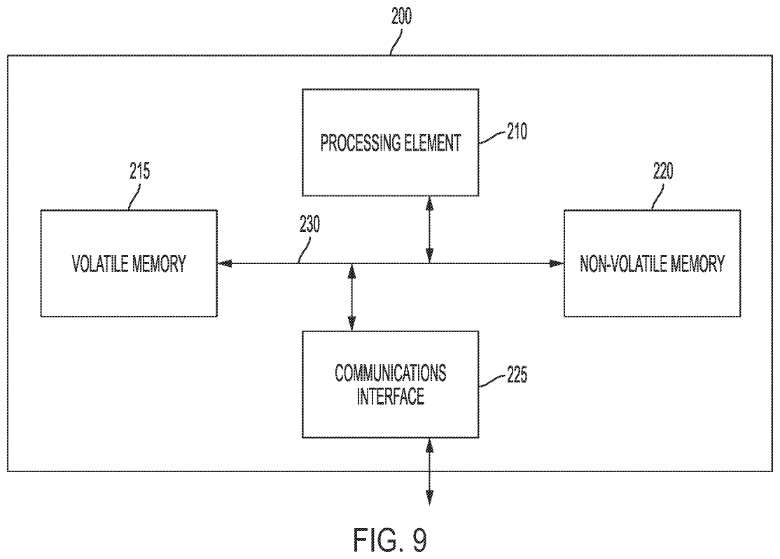

FIG. 9 provides a schematic of a computing entity 200 that may be used in accordance with various embodiments of the present disclosure. For instance, the computing entity 200 may host SoCCom 115 implementing various embodiments of the tool flow, described above. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

Although illustrated as a single computing entity, those of ordinary skill in the art should appreciate that the computing entity 200 shown in FIG. 2 may be embodied as a plurality of computing entities, tools, and/or the like operating collectively to perform one or more processes, methods, and/or steps. As just one non-limiting example, the computing entity 200 may comprise a plurality of individual data tools, each of which may perform specified tasks and/or processes.

Depending on the embodiment, the computing entity 200 may include one or more network and/or communications interfaces 225 for communicating with various computing entities, such as by communicating data, content, information, and/or similar terms used herein interchangeably that can be transmitted, received, operated on, processed, displayed, stored, and/or the like. Thus, in certain embodiments, the computing entity 200 may be configured to receive data from one or more data sources and/or devices as well as receive data indicative of input, for example, from a device.

The networks used for communicating may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks may have any suitable communication range associated therewith and may include, for example, global networks (e.g., the Internet), MANs, WANs, LANs, or PANs. In addition, the networks may include any type of medium over which network traffic may be carried including, but not limited to coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Accordingly, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The computing entity 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In addition, in various embodiments, the computing entity 200 includes or is in communication with one or more processing elements 210 (also referred to as processors, processing circuitry, and/or similar terms used herein interchangeably) that communicate with other elements within the computing entity 200 via a bus 230, for example, or network connection. As will be understood, the processing element 210 may be embodied in several different ways. For example, the processing element 210 may be embodied as one or more complex programmable logic devices (CPLDs), microprocessors, multi-core processors, coprocessing entities, application-specific instruction-set processors (ASIPs), and/or controllers. Further, the processing element 210 may be embodied as one or more other processing devices or circuitry. The term circuitry may refer to an entirely hardware embodiment or a combination of hardware and computer program products. Thus, the processing element 210 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 210 may be configured for a particular use or configured to execute instructions stored in volatile or non-volatile media or otherwise accessible to the processing element 210. As such, whether configured by hardware, computer program products, or a combination thereof, the processing element 210 may be capable of performing steps or operations according to embodiments of the present disclosure when configured accordingly.

In various embodiments, the computing entity 200 may include or be in communication with non-volatile media (also referred to as non-volatile storage, memory, memory storage, memory circuitry and/or similar terms used herein interchangeably). For instance, the non-volatile storage or memory may include one or more non-volatile storage or memory media 220 such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media 220 may store files, databases, database instances, database management system entities, images, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

In some embodiments, the memory media 220 may also be embodied as a data storage device or devices, as a separate database server or servers, or as a combination of data storage devices and separate database servers. Further, in some embodiments, the memory media 220 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. As already discussed, various embodiments contemplated herein use data storage in which some or all the information/data required for various embodiments of the disclosure may be stored.

In various embodiments, the computing entity 200 may further include or be in communication with volatile media (also referred to as volatile storage, memory, memory storage, memory circuitry and/or similar terms used herein interchangeably). For instance, the volatile storage or memory may also include one or more volatile storage or memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media 215 may be used to store at least portions of the databases, database instances, database management system entities, data, images, applications, programs, program modules, scripts, source code, object code, byte code, compiled code, interpreted code, machine code, executable instructions, and/or the like being executed by, for example, the processing element 210. Thus, the databases, database instances, database management system entities, data, images, applications, programs, program modules, scripts, source code, object code, byte code, compiled code, interpreted code, machine code, executable instructions, and/or the like may be used to control certain aspects of the operation of the computing entity 200 with the assistance of the processing element 210 and operating system.

As will be appreciated, one or more of the computing entity's components may be located remotely from other computing entity components, such as in a distributed system. Furthermore, one or more of the components may be aggregated and additional components performing functions described herein may be included in the computing entity 200. Thus, the computing entity 200 can be adapted to accommodate a variety of needs and circumstances.

1. A computer-implemented method for generating a system-on-chip (“SoC”) design comprises:
receiving a specification of the SoC design;
retrieving a plurality of IP blocks defined by the specification from a design library;
extracting design metadata associated with the plurality of IP blocks;
generating a standardized interface for each of the plurality of IP blocks in accordance with the design metadata;
generating a bus interface for the plurality of IP blocks;
receiving configuration information for the plurality of IP blocks; and
generating a tiled synthesizable register-transfer level code for the SoC design in accordance with the configuration information.

2. The method of claim 1 wherein said SoC further comprises a network-on-chip fabric.

3. The method of claim 2 wherein said SoC further comprises a security policy engine configured to implement one or more security policies.

4. The method power of claim 1 wherein said SoC comprises a plurality of test wrappers associated with the plurality of IP blocks.

5. The method of claim 1 wherein said SoC comprises a plurality of security wrappers associated with the plurality of IP blocks.

6. The method of claim 5 wherein said security wrappers are configured to facilitate on-the-fly enforcement of security policies by run-time monitoring and detection of signals used in the SoC.

7. The method of claim 6 wherein said security wrappers are configured to apply obfuscation/logic-locking keys to the SoC design.

8. The method of claim 7 wherein said SoC comprises a plurality of design-for-debug wrappers.

9. The method of claim 1 further comprising:
optimizing the SoC design for performance.

10. The method of claim 1 further comprising:
optimizing the SoC design for area usage.

11. The method of claim 1 further comprising:
optimizing the SoC design for power consumption.

12. The method of claim 1 further comprising:
wherein said bus interface is coupled to a hierarchical bus enabling communication between the plurality of IP blocks.

13. A system comprising:
a memory storing instructions; and
a processor, coupled with the memory and configured to execute the instructions, the instructions when executed causing the processor to:
receive a specification of a system-on-chip (“SoC”) design;
retrieve a plurality of IP blocks defined by the specification from a design library;
extract design metadata associated with the plurality of IP blocks;
generate a standardized interface for each of the plurality of IP blocks in accordance with the design metadata;
generate a bus interface for the plurality of IP blocks;
receive configuration information for the plurality of IP blocks; and
generate a tiled synthesizable register-transfer level code for the SoC design in accordance with the configuration information.

14. The system of claim 13 wherein said SoC further comprises a network-on-chip fabric.

15. The system of claim 14 wherein said SoC further comprises a security policy engine configured to implement one or more security policies.

16. The system of claim 12 wherein said SoC comprises a plurality of test wrappers associated with the plurality of IP blocks.

17. The system of claim 12 wherein said SoC comprises a plurality of security wrappers associated with the plurality of IP blocks.

18. The system of claim 17 wherein said security wrappers are configured to facilitate on-the-fly enforcement of security policies by run-time monitoring and detection of signals used in the Soc.

19. The system of claim 12 wherein said security wrappers are configured to apply obfuscation/logic-locking keys to the SoC design.

20. The system of claim 12 wherein said SoC comprises a plurality of design-for-debug wrappers.

21. The system of claim 12 wherein the SoC design is optimized for performance.

22. The system of claim 12 wherein the SoC design is optimized for area usage.

23. The system of claim 12 wherein the SoC design is optimized for power consumption.

24. The system of claim 12 wherein said bus interface is coupled to a hierarchical bus enabling communication between the plurality of IP blocks.
